(19) United States
(12) Patent Application Publication
(10) Pub. No.: US 2025/0235849 A1
(43) Pub. Date: Jul. 24, 2025

(54) Processes For Removing Contaminants From Contaminated Surfaces

(71) Applicant: GUILD ASSOCIATES INC., DUBLIN, OH (US)

(72) Inventors: Kristian Farve, Dayton, OH (US); Michael J. Knapke, Plain City, OH (US); Joseph A. Rossin, Columbus, OH (US); Rachel L. Harding, Dublin, OH (US); Lauren Sherry, Cambridge, OH (US)

(73) Assignee: GUILD ASSOCIATES INC., DUBLIN, OH (US)

(21) Appl. No.: 18/418,566

(22) Filed: Jan. 22, 2024

Related U.S. Application Data
(60) Provisional application No. 63/590,963, filed on Oct. 17, 2023.

(51) Int. Cl. B01J 20/28; A41D 13/08; A62D 3/30; A62D 101/02; B01J 20/08; B01J 20/18; B01J 20/20

(52) U.S. Cl. CPC B01J 20/2804; A41D 13/081; A62D 3/30; B01J 20/08; B01J 20/18; B01J 20/20; B01J 20/28035; A62D 2101/02

(57) ABSTRACT

The present disclosure is directed to the removal of contaminants from a contaminated surface in the field. According to one embodiment, the present disclosure is directed to a textile comprising immobilized contaminant surface removal media for contacting a contaminated surface and removal of contamination. According to a further embodiment, the present disclosure is directed to a hand mitt comprising at least one outward facing textile side comprising immobilized contaminant surface removal media. According to another embodiment, the present disclosure is directed to a process for the removal of contaminants from a surface comprising contacting a contaminated surface with a textile comprising immobilized contaminant surface removal media and thereafter disposing of the textile including removed contaminants.

### BACKGROUND

Immediate decontamination operations are performed by military personnel for the purpose of removing a majority of liquid phase chemical warfare agents (CW agents) from contaminated surfaces following chemical agent exposure. Examples of chemical agents include Tabun (GA), Soman (GD), Sarin (GB), O-ethyl-S-(2-diisopropyl-aminoethyl) methyl phosphonothioate (VX), and bis-(2-chloroethyl) sulfide (HD). Immediate decontamination is performed immediately following chemical exposure and targets removal of the majority (for example, greater than about 90% and more preferably greater than 99%) of toxic chemical from the external surface of the contaminated item, which may include for example, weapons, communication equipment, garments, ruck sacks, goggles, and vehicles, etc. The purpose of immediate decontamination is to (1) minimize contact hazards associated with the contaminated surface, (2) minimize the spread of CW agents and (3) to lessen the burden on subsequent thorough decontamination operations.

Currently, an M295 decontamination mitt is employed in immediate decontamination operations by the US military. The M295 mitt is well known to one skilled in the art. Briefly, the M295 is comprised of a polyethylene mitt designed to fit over one hand (either left or right). A piece of pad material is located on the face or palm-side of the mitt. Located between the pad material and the polyethylene mitt is decontamination media, such as a silica-aluminum oxide media. Referred to as A-200, the A-200 media is a reactive adsorbent capable of rapidly absorbing toxic CW agents and decomposing all or a portion of the absorbed CW agent. The A-200 powder has an average particle size on the order of 30 μm. The mitt functions by allowing the decontamination media to pass through the pad material, with the released decontamination media contacting the contaminated surface by means of physical action involving the mitt and absorbing the toxic chemical into its pores. Rubbing the loose decontamination media across the surface of the contaminated item is effective in its ability to remove CW agents from said contaminated item. Direct contact between the decontamination media and the contaminated surface results in the CW agent absorbing into the pores of the decontamination media, removing a significant fraction of the CW agent from the contaminated surface associated with the item being decontaminated.

When performing immediate decontamination operations, it is desired to limit the spread of CW agent. One does not want to transfer CW agent from a contaminated item to an uncontaminated item. Further, one desires to limit hazards associated with operators, namely hazards associated with inhalation of CW agent and contact of CW agent with exposed skin.

One drawback associated with the use of loose decontamination media in immediate decontamination operations, such as in the case of the M295, is that the loose decontamination media is free to move about as a dust and spread CW agent, especially when applied during windy conditions where the contaminated media becomes airborne. By not being immobilized in the mitt, the loose decontamination media (containing absorbed CW agent) has the potential to (1) pose an inhalation or human contact threat, (2) spread toxic chemical to non-contaminated items and (3) get in mechanisms and electronics which may lead to malfunctions of the item being cleaned, such as for example, a weapon or laptop computer.

### SUMMARY

A process whereby the decontamination operation is performed using a decontamination media adhered to and/or anchored in a textile would offer significant advantages over a process whereby the loose decontamination media is applied directly to the surface. Said advantages associated with the process would eliminate (1) inhalation hazards associated with the loose contaminated particle becoming airborne, (2) the spread of toxic chemicals and (3) damage to mechanical and electronic components. To be viable however, the decontamination media must be applied to the textile in a manner that allows the textile to (1) remain flexible, (2) not shed decontamination media, (3) allow the decontamination media to retain sufficient porosity for chemical absorption and (4) not significantly affect the surface (reactive) properties of the decontamination media. In addition, sufficient decontamination media must be applied to the textile such that the textile has the capacity to absorb the CW agent from the contaminated surface.

Process: The novel process described herein relates to a hand operated method for the removal of chemical warfare agents (CW agents) from a contaminated surface. The novel process described herein is a surface technique and as such is limited to the removal of CW agent at the external surface, versus CW agent that is absorbed, dissolved or otherwise present below the external surface. For example, the novel process will not remove a significant fraction of CW agent dissolved into paints and plastics. Rather, the novel process described herein is limited to the removal of CW agent present only at the external surface of contaminated items. Examples of contaminated surfaces include those associated with military equipment and may include for example metallic surfaces, painted surfaces, wooden surfaces, textile surfaces, plastic surfaces, and coated surfaces. In its simplest form, the novel process involves contacting the contaminated surface, such as for example a surface contaminated with CW agent, with a textile onto which absorptive or reactive/absorptive media, or mixtures thereof, are immobilized and/or substantially anchored. Glues, adhesives, and polymer melts, for example, may be used to immobilize the decontamination media to the textile. Examples of textiles may include for example those prepared from synthetic and/or natural fibers. Said textile may be knitted, woven or non-woven. The textile should be flexible to allow the process to be applied to non-conformal surfaces, such as for example the barrel of a rifle, chemical protective garment, goggles, etc.

As used herein, the textile onto which absorptive or reactive/absorptive media, or mixtures thereof are immobilized will be referred to as a “Immobilized-Media Textile (IMT)”. The media is applied to at least one side of the textile. In a preferred IMT configuration, the face side of the textile is comprised of media, while an impermeable or semi-impermeable material, such as for example a polyethylene film, is adhered to the back side of the IMT. In this manner, the operator can utilize the IMT without contaminating the operator's hand. The IMT is applied to the contaminated surface, such as for example via a rubbing action, in a manner such that the media side of the IMT directly contacts the contaminated surface, removing the CW agent.

In a preferred process, the contaminated surface is first contacted with the IMT to remove a majority of the CW agent from the external surface. Once this operation is complete, the surface is then contacted a second time using a clean (fresh) piece of IMT. More preferably, the IMT may be configured as a dual-sided mitt, whereby the surface is decontaminated using one side of the mitt. The mitt is rotated 180 degrees on the hand and the surface is then decontaminated using the other side of the mitt. The process removes residual CW agent from the surface. As was discovered during the development of the novel process described herein, the treatment with both sides of the mitt improved the process's ability to decontaminate the surface.

The novel process described herein may also be applied to the removal of CW agent from surfaces also contaminated with other liquids such as, for example fuel, salt spray, rain, etc. The novel process described herein may also be applied to the decontamination of surfaces contaminated with toxic industrial chemicals (TICs), acidic solutions and alkaline solutions.

Configuration: The IMT associated with the novel process described herein may be employed in a variety of configurations so long as the media side (face side) of the IMT directly contacts the contaminated surface. In its simplest form, the IMT is configured in the form of a cloth, rag, pad, or other forms that allow for contacting the face side of the IMT with the contaminated surface. In a preferred configuration, the IMT is configured in the form of a mitt, with at least a portion of the mitt, such as for example the area covering the palm of the hand, the area covering the palm and fingers of the hand, etc. comprised of the IMT. In a more preferred configuration, at least a portion of both sides of the mitt are comprised of IMT, with at least a portion of each side of the mitt being comprised of media loaded textile. Said configuration will allow both sides of the mitt to be utilized, thereby providing enhanced capabilities. Some enhanced capabilities would include, for example, decontaminating a larger contaminated area or decontaminating the same surface with both sides of the same mitt to achieve a higher level of decontamination.

In an even more preferred configuration, the mitt will be comprised entirely of the IMT, with the textile extending from the tip of the fingers to below the wrist. The mitt may also be configured with a system to secure the mitt to the wrist, such as for example a Velcro strap or pull string. In its preferred configuration, the mitt is designed to be used by either the left hand or the right hand.

An additional feature of the configuration according to one embodiment is a fold-over edge that will allow the operator to use the device in corners and other tight areas.

Media: The media associated with the textile employed in the novel process plays a significant role in the removal of CW agent from the contaminated surface. It is desired that the media have a high porosity to accommodate liquid chemical agents. Examples of high porosity media to be immobilized onto the textile and employed in the novel process include for example carbons, zeolites, metal oxides and metal oxyhydroxides. Carbons, although possessing a high porosity, are relatively inert in their ability to detoxify chemical agents.

Media that include zeolites, metal oxides and metal oxyhydroxides offer the capability to destroy CW agents and are referred to herein as reactive sorbents. Examples of porous carbons include carbons prepared by carbonization coal, coconut shell or polymers. Examples of zeolites include zeolite X, zeolite Y and zeolite ZSM-5 (MFI). Examples of metal oxides include MgO, TiO₂, ZrO₂, SiO₂ and Al₂O₃. The A-200 decontamination powder employed in the M295 is an example of a metal oxide. Examples of metal oxy-hydroxides include zirconium oxy-hydroxide, aluminum oxy-hydroxide, pseudo-boehmite and mixed-metal oxy-hydroxides such as those described in U.S. Pat. No. 10,625,239.

Metal oxyhydroxides are believed to be preferred due to both their porosity, pore structure and reactivity. Metal oxyhydroxides are comprised of both bridging oxygen and terminal hydroxyl groups. While not wishing to be bound by any theory, the bridging oxygen associated with the oxyhydroxide provides porosity while the terminal hydroxyl groups provide reactive sites. Metal oxyhydroxides differ from metal oxides and metal hydroxides in that they possess both bridging oxygen (as associated with metal oxides) and terminal hydroxyl groups (as associated with metal hydroxides).

### BRIEF DESCRIPTION OF DRAWINGS

FIG. 1 shows a front perspective view of a mitt, wherein the mitt is in a ready-to-be-worn configuration.

FIG. 2 shows a front perspective view of the mitt shown in FIG. 1, wherein the mitt is in a hand receiving configuration.

FIG. 3 shows a right-side view of the mitt in the hand receiving configuration as shown in FIG. 2.

FIG. 4 shows a left-side view of the mitt in the hand receiving configuration as shown in FIGS. 2-3.

FIG. 5 shows a top view of the mitt in the hand receiving configuration as shown in FIGS. 2-4.

FIG. 6 shows a bottom view of the mitt in the hand receiving configuration as shown in FIGS. 2-5.

FIG. 7 shows a front perspective view of the mitt shown in FIGS. 1-14, wherein the mitt is in a worn configuration.

FIG. 8 shows a front elevation of the mitt in the worn configuration as shown in FIG. 7.

FIG. 9 a rear elevation of the mitt in the worn configuration as shown in FIGS. 7-8.

FIG. 10 shows a right side view of the mitt in the worn configuration as shown in FIGS. 7-9.

FIG. 11 shows a left side view of the mitt in the worn configuration as shown in FIGS. 7-10.

FIG. 12 shows a top view of the mitt in the worn configuration as shown in FIGS. 7-11.

FIG. 13 shows a bottom view of the mitt in the worn configuration as shown in FIGS. 7-12.

FIG. 14 shows an embodiment of an IMT with the media located at the face of the textile, with an impermeable or semi-impermeable backing material applied to the backside of the textile.

FIG. 15 shows an embodiment of an IMT configured in the form of a dual-sided mitt with a preferred fold-over edge.

FIG. 16 shows a seam of an embodiment of an IMT shown in FIG. 15.

### DESCRIPTION OF EMBODIMENTS

When conducting immediate decontamination operations, it is desired to minimize the spread of CW agent. Minimizing the spread of CW agent includes not only CW agent associated with the contaminated surface, but also CW agent associated with the decontamination equipment. To minimize the spread of CW agent associated with the textile, it is desirable that the used textile transfer little or no CW agent upon contact with an outside agency. Minimizing the transfer of CW agent from the used textile can be accomplished using embodiments disclosed herein by either strongly retaining the CW agent within the pores of the media immobilized in the textile, or by the detoxifying the CW agent within the pores of the media immobilized in the textile, or by a combination of strong retention (absorption) and chemical reaction.

Process: The present invention relates to embodiments of a novel process for the removal of CW agents from contaminated surfaces employing a hand-held device. Examples of contaminated surfaces may include for example metallic surfaces (e.g., aluminum, stainless steel), painted surfaces (e.g., those painted with chemical agent resistant coating—CARC), wooden surfaces, textile surfaces (e.g., chemical protective suits), plastic surfaces (e.g., polyethylene, polycarbonate) and coated surfaces. Said surfaces are associated with items that include for example weapons, uniforms, furniture, tents, backpacks and rucksacks, computers, goggles, and lenses. In its simplest form, some embodiments of the novel processes disclosed herein involve contacting the CW agent contaminated surface with a textile onto which absorptive or reactive/absorptive media, or mixtures thereof, are immobilized, anchored, or otherwise adhered through use of an adhesive, binder, or polymer melt. Techniques for immobilizing/anchoring/adhering media onto textiles include but are not limited to using adhesives, binders and polymer melts as known to one skilled in the art. As used herein, the textile onto which absorptive or reactive/absorptive media, or mixtures thereof are immobilized/anchored/adhered will be referred to as a “IMT”. As we discovered, to be effective, the media must be applied to at least one face of the textile as opposed to for example merely contained within the textile fibers or between layers of textile. This is because it is preferred to contact the media directly with the contaminated surface to rapidly absorb the CW agent. The media does not have to be applied as a monolayer, but rather and more preferably can be applied as multiple layers. Locating the media on the face of the textile allows for the media to be directly contacted with the contaminated surface, thereby allowing for the rapid and effective absorption of CW agent from the contaminated surface.

The novel process described herein is a surface technique and as such is limited to the removal of CW agent at or very near to the external surface, versus CW agent that is absorbed, dissolved into or otherwise present below the external surface. For example, the novel process will not remove a significant fraction of CW agent dissolved into paints and plastics, for example. Rather, the novel process described herein is limited to the removal of CW agent present only at the external surface of contaminated items. In cases involving surfaces that absorb or allow the agent to be dissolved within, such as for example a metallic surface painted with CARC, it becomes necessary to not only treat the surface shortly after chemical contamination employing the novel process described herein, such as for example within one minute following chemical contamination, but to also absorb the chemical rapidly from the surface. If the CW agent is not rapidly absorbed by treatment using the novel process described herein, the removal of CW agent from the surface will be reduced, likely due to a portion of CW agent being forced into the surface.

In its simplest form, some embodiments of the process disclosed herein involve contacting the contaminated surface with the face side of the IMT using the IMT configured as a cloth, rag or similar form of sufficient size and media loading to treat a contaminated surface. The method of contact may involve, for example rubbing or dabbing the face side of the IMT onto the contaminated surface.

When testing, it was discovered that the chemical being removed from the surface tended to accumulate at pressure points, associated with the IMT. For example, when testing the process using the IMT configured as a mitt, the chemical associated with the used mitt was noticeable at the areas covered by the fingers and the palm of the hand. Said observations indicated that the IMT was not uniformly contacted over the entire working area. This limited the ability to decontaminate the surface, or limited the amount of chemical that could be removed from the surface using a mitt comprised of IMT affixed to only one side.

In a preferred embodiment of a process disclosed herein, the IMT may first be contacted with the contaminated surface then discarded once complete. The novel process may then be repeated using a fresh piece of IMT, contacting the contaminated surface for a second time. As we discovered, when applying the IMT to the surface, the chemical may become absorbed primarily at the pressure points of the hand on the IMT. This limits the capacity of the IMT. Another treatment of the same surface with another piece of IMT greatly improves the decontamination capability of the novel process described herein by removing the residual CW agent from the surface, and by removing any CW agent droplets that may not have been previously absorbed.

The textile which comprises the IMT can vary widely, so long as the textile is flexible and allows for adhesion of the media. Examples of textiles may include such as for example those prepared from synthetic and/or natural fibers. The textile may be knitted, woven or non-woven. The textile should be flexible to allow the process to be applied to non-conformal surfaces, such as for example the barrel of a rifle, chemical protective garment, goggles, etc.

A preferred embodiment of a process described herein, may employ a IMT whereby the face side of the textile may be comprised of media, and whereby an impermeable or semi-impermeable material, such as for example a polyethylene film, may be adhered to the back side of the IMT. Alternatively, the impermeable or semi-impermeable material may be merely located behind the IMT as a layer, e.g., a separate layer. IMT onto which an impermeable or semi-impermeable material may be adhered may be preferred. In this manner, the novel process may be performed with little or no contamination of the operator's hand.

The process may also be applied to the removal of CW agent from surfaces containing, in addition to CW agents, other liquids such as for example fuel droplets, salt spray, rain, etc. For example, a surface with salt spray may become contaminated with CW agent. The novel process described herein may also be applied to the decontamination of surfaces contaminated with other hazardous or toxic chemicals, such as for example toxic industrial chemicals (TICs), acidic solutions and alkaline solutions.

The novel process described herein is a surface process and may effectively remove greater than 90% of CW agent from the external surface of an item. For example, an embodiment of the novel process described herein will not remove CW agent that has absorbed into or dissolved into surfaces, coatings, etc. Rather, the novel process described herein is a purely external surface process and as such is limited to the removal of CW agent present at the external surface of objects, equipment, or items. Due to the external surface nature of the novel process, it may be desired to utilize an embodiment of the novel process described herein shortly after a surface is contaminated with CW agent to minimize the absorption of the CW agent into the surface. For example, the novel process should be initiated shortly after a surface has been contacted with CW agent, especially surfaces that allow for the absorption or dissolution of CW agent such as for example surfaces comprised of paints, plastics, and elastomers. Preferably, the novel process may be initiated in less than about 15 minutes after chemical contact, more preferably less than about 5 minutes and still more preferably in less than about 1 minute.

Embodiments of the novel process described herein may be operated over a wide range of environmental conditions (temperatures and humidities), ranging from below about −25° F. to greater than about 120° F., and from relative humidities less than about 5% to about 90%.

Configuration: Embodiments of some IMTs associated with the novel processes described herein may be employed in a variety of configurations so long as the media side (face side) of the IMT directly contacts the contaminated surface. In its simplest form, according to some embodiments disclosed herein, the IMT may be configured in the form of a cloth, rag, pad, or other forms. In some preferred configurations, the IMT may be configured in the form of a mitt, with at least a portion of the mitt, such as the area covering the palm side of the hand, may be comprised of the IMT. The mitt configuration embodiment is preferred, as said configuration allows the IMT to effectively contact the surface as opposed to for example a cloth configuration whereby the cloth is bunched in the hand. In a more preferred embodiment, both sides of the mitt may be comprised of IMT, with at least a portion of each side of the mitt, such as the area that would cover the palm and the back of the hand, is comprised of media loaded textile. Said configuration will allow the mitt to be rotated on the hand, thereby providing enhanced capabilities from a single mitt. In the most preferred configuration, the mitt may be comprised entirely of the IMT, with the mitt extending below the palm of the hand. The mitt may also be configured with a system to secure the mitt to the wrist, such as for example a Velcro strap or pull string. It may also be desired that the mitt is designed to accommodate both the left hand and the right hand.

When employing an IMT configured as a mitt, it may be desirable that a backing material be adhered to the media loaded textile whereby the backing material is impermeable or semi-impermeable to the CW agent. Alternatively, it may be desirable that the mitt be lined with an impermeable or semi-impermeable material. Said liner may prevent or minimize the CW agent from passing through the IMT and contacting the operator's exposed hand or glove.

When employing a IMT configured as a mitt, it may be desirable in some embodiments that the mitt extend past the palm of the hand. Preferably, it may be desirable that the mitt extends at least 3″ past the palm of the hand, and more preferably at least 6″ past the palm of the hand. This may be desirable because during use, portions of the forearm below the palm of the hand have the potential to contact the CW agent contaminated surface.

According to some embodiments disclosed herein, it may be further desirable for the entire mitt to be comprised of IMT. This may be desirable because when in use, portions of the mitt below the palm of the hand may contact the CW agent contaminated surface. In this manner, any CW agent that encounters any portion of the mitt, including portions below the palm of the hand, may be absorbed.

When employing an IMT configured as a mitt, it may be desirable for the mitt to be configured to be operable with either the left hand or the right hand.

The IMT employed by some embodiments of the novel process described herein should be of sufficient size and contain sufficient media to remove that target amount of CW agent associated with the target area. The processes described herein may be intended to be used as a hand-held device by a single operator and as such, is intended to be of sufficient size to allow the operator to treat a surface contaminated with up to about 1 g of CW agent, and preferably up to about 3 g of CW agent, and more preferably up to about 10 g of CW agent, and still more preferably up and in excess of about 15 g of CW agent using a single, hand-held device. Preferably, the size of the IMT may be at a minimum of about 4″ by 5″ (20 square inches), and preferably at least about 50 square inches, and more preferably at least about 100 square inches. The media loading should be at least about 0.01 g per square inch, preferably at least about 0.1 g per square inch, and more preferably at least 0.2 g per square inch.

When configuring an IMT in the form of a mitt, it is preferred according to some embodiments for the mitt to be capable of being turned inside out following use such that the final step in the preferred process will be turning the used mitt inside out. This will greatly minimize the contact hazard associated with a spent mitt, as the contaminants are now encased.

Media: The media associated with the textile employed by the novel processes described herein may play a significant role in the removal of CW agent from a contaminated surface. Further, the media associated with the IMT employed in the novel processes will play a significant role in the contact hazard associated with a used mitt. As used herein, contact hazard refers to the transfer of CW agent from a contaminated surface, either prior to or following decontamination. It is desired that the media have a high porosity to accommodate liquid chemical agents associated with the contaminated surface. Media with pore volumes, as measured using N₂ or O₂ adsorption techniques known to one skilled in the art, greater than about 0.2 cm³/g may be preferred. Media with pore volumes greater than about 0.5 cm³/g may be more preferred and media with pore volumes greater than about 0.8 cm³/g may be further preferred. Examples of media to be immobilized onto the textile and employed in the novel processes disclosed herein include but are not limited to carbons, zeolites, metal oxides and/or metal oxy-hydroxides and mixtures thereof. Resins, metal organic framework (MOF) and other porous solids and mixtures thereof may also be considered. Carbons, although possessing a high porosity, are relatively inert in their ability to detoxify chemical agents but may also be employed. Media that include for example zeolites, metal oxides and/or metal oxy-hydroxides and mixtures thereof may offer the capability to destroy the toxic chemical, and thus may be referred to as reactive sorbents. Examples of porous carbons useful herein include but are not limited to carbons prepared by carbonization coal, coconut shell or polymers. Examples of zeolites useful herein include but are not limited to zeolite X, zeolite Y and zeolite ZSM-5 (MFI) and mixtures thereof. Examples of metal oxides that are useful herein include but are not limited to magnesium oxide (MgO), titanium dioxide (TiO₂), zirconium dioxide (ZrO₂), silicon dioxide (SiO₂) and aluminum oxide (Al₂O₃) and mixtures thereof. As noted, mixed metal oxides are also included such as for example the A-200 decontamination media and silicon-aluminum oxide and mixtures thereof. Examples of metal oxy-hydroxides useful herein include but are not limited to zirconium oxy-hydroxide, aluminum oxy-hydroxide, pseudo-boehmite and mixed-metal oxy-hydroxides such as for example those described in U.S. Pat. No. 10,625,239 which is herein incorporated by reference.

Metal oxyhydroxides and mixed-metal oxy-hydroxides may be preferred according to some embodiments due to a combination of their high porosity, pore structure and reactivity. Metal and mixed-metal oxy-hydroxides may be comprised of both bridging oxygen and terminal hydroxyl groups. While not wishing to be bound by any theory, the bridging oxygen associated with the metal or mixed-metal oxyhydroxide may provide porosity while the terminal hydroxyl groups may provide reactive sites. Metal oxyhydroxides differ from metal oxides and metal hydroxides in that they possess both bridging oxygen (as associated with metal oxides) and terminal hydroxyl groups (as associated with metal hydroxides).

According to some preferred embodiments disclosed herein, media that is both absorptive and reactive may be preferred over media that is merely absorptive. Preferred media, according to some embodiments, include but are not limited to zirconium oxy-hydroxide, pseudo-boehmite, aluminum oxy-hydroxide, oxy-hydroxides comprised of aluminum and silicon, and oxy-hydroxides comprised of zinc, iron and silicon and mixtures thereof.

The media to be employed in a IMT by the novel processes described herein may be best used as a fine powder adhered to or anchored to the textile. As used herein, a fine powder is defined as particles of less than about 100 μm in size, preferably less than about 30 μm in size, and more preferably less than about 10 μm in size. Use of small particles may be important to the processes, as the small particles possess a high geometric surface area (weight or volume basis) which is—while not wishing to be limited to any theory—believed to be beneficial for the rapid absorption of liquid chemical from a contaminated surface. Further, the fine powder may be applied to the textile in multiple layers, which may greatly increase the effectiveness of the novel processes. Still further, we have found that smaller particles adhere better or are anchored more securely to the textile as is necessary to minimize shedding.

According to some embodiments disclosed herein, when using porous solids, it may be desired that a toxic chemical be rapidly absorbed from the surface. Therefore, it may be desired that the porous solid be highly mesoporous versus highly microporous. Should absorption of toxic chemicals into the pores of the porous solid not be rapid, application of the porous solid to the contaminated surface may result in spreading the chemical across the surface and increasing the time required to complete the decontamination operation.

Testing Procedure: Chemical warfare agents represent an extreme class of toxic chemicals that may be deployed as part of a military action. Chemical warfare agent simulants are used for the purpose of evaluating decontamination processes on a large scale. This is due to hazards associated with using quantities of extremely toxic CW agents that may exceed 1 g. Thus, chemical agent testing is often limited to small, laboratory efforts involving the use of microgram quantities of CW agents. As used herein, simulants are defined as compounds with physical properties and structures similar to a target CW agent, but far less toxic. Simulants for CW agents are well known to one skilled in the art. Examples of CW agent simulants include but are not limited to 2-chloroethyl ethyl sulfide (CEES) and 2-chloroethyl phenyl sulfide (CEPS) as simulants for HD, dimethyl methyl phosphonate (DMMP) as a simulant for G-agent, and O, S diethyl phenyl phosphonothioate (DPPT) as a simulant for VX.

Much of the testing described herein was performed using an IMT configured as a mitt. The IMT was prepared in the form of a mitt 7.5″ wide by 11″ long, with said mitt being comprised entirely of IMT including a laminated lining on the inside using a polyethylene film as an impermeable backing material. Testing involved contaminating a surface with CW agent simulant. Following contamination, the surface was treated according to one of the novel processes described herein. Following treatment, the surface was washed with solvent, and the solvent collected and evaluated for residual chemical agent simulant. The extent of decontamination (referred to as decontamination efficacy) was calculated by subtracting from unity the amount of CW agent simulant present in the solvent divided by the amount of CW agent simulant initially added to the surface, with the quantity multiplied by 100%. For example, if 10 g of CEES simulant was added to the surface, and 1 g of CEES simulant was present in the solvent, the decontamination efficacy would be reported as 90%-representing a 90% removal of the simulant ((1 1/10)×100%=90% decontamination efficacy).

When determining the ability of an IMT mitt to destroy the CW agent simulant, the mitt was placed in a jar and allowed to stand for 24 hours. Following 24 hours, solvent was added to the jar to extract any unreacted CW agent simulant from the mitt. The solvent was then analyzed for residual CW agent simulant. The conversion of CW agent simulant was determined by subtracting from unity the amount of CW agent simulant extracted from the used mitt by the amount of CW agent absorbed by the mitt, with the quantity multiplied by 100%. For example, if 10 g of CEES simulant was added to the surface, and 1 g of CEES simulant was not removed from the surface, then 9 g of CW agent was absorbed into the mitt. If 1 g of CW agent simulant was extracted from the spent mitt, the conversion of CW agent simulant would be reported as 89%-indicating that 89% of the CW agent simulant was destroyed by the media associated with the IMT ((1 1/9)×100%=89% conversion).

### EXAMPLES

### Example 1

Comparative: A 10.7 square foot aluminum surface was contaminated with 10 g of CW agent simulant DMMP. The DMMP was applied as small droplets evenly across the surface. A M295 decontamination mitt was used to decontaminate the surface. Approximately half-way through the operation, the mitt began to clog due to the DMMP saturating the pad material and the decontamination powder was no longer released from the mitt. Upon completion of the operation, a noticeable film of DMMP was evident on the surface. Any loose powder was brushed from the surface. The panel was subsequently evaluated for residual DMMP. The decontamination efficacy achieved by the M295 was about 88.9±0.9%.

A 10.7 square foot aluminum surface was contaminated with 10 g of CW agent simulant CEPS. The CEPS was applied as small droplets evenly across the surface. A M295 decontamination mitt was used to decontaminate the surface. Approximately half-way through the operation, the mitt began to clog, and the decontamination powder was no longer released from the mitt. Upon completion of the operation, a noticeable film of CEPS was evident on the surface. Any loose powder was brushed from the surface. The panel was subsequently evaluated for residual CEPS. The decontamination efficacy achieved by the M295 was about 88.2±3.4%.

A 10.7 square foot aluminum surface was contaminated with 10 g of salt water plus 10 g of CW agent simulant DMMP. Both the salt water and DMMP were applied as small droplets evenly across the surface. A M295 decontamination mitt was used to decontaminate the surface. The mitt began to clog early into the operation and the decontamination powder was no longer released from the mitt. Upon completion of the operation, a noticeable liquid film was evident on the surface. Any loose powder was brushed from the surface. The panel was subsequently evaluated for residual DMMP. The decontamination efficacy achieved by the M295 was about 79.6±1.4%.

It should be noted that all decontamination operations were performed within a fume hood. Due to the air currents within the hood, it was observed that a portion of the loose media could be observed to blow around within the fume hood, ultimately settling into corners of the hood. The movement of loose media contaminated with chemical simulant, especially that which becomes airborne, would be anticipated to present an inhalation hazard to unprotected individuals. The loose media contaminated with CW agent would also present a contact hazard should the loose media come into contact with an unprotected individual or surface.

The M295 was applied to the loaded cartridge associated with a rifle. Following application, difficulty was encountered in removing the cartridge from the rifle. Said difficulty was attributed to the presence of the loose media.

The M295 was applied to the keyboard of a laptop computer. Following application, selected keys of the keyboard did not function because of loose media affecting operation.

### Example 2

This example describes decontamination of a surface via one treatment with a textile comprising immobilized zirconium oxyhydroxide according to one embodiment of the present disclosure. A 10.7 square foot aluminum surface was contaminated with 10 g of CW agent simulant DMMP. The DMMP was applied as small droplets evenly across the surface. A 50 square inch (in²) piece of textile comprising 0.18 g per square inch (g/in²) immobilized zirconium oxyhydroxide on the face side and laminated with a polyethylene film on the back side was used to decontaminate the surface. The cloth was somewhat difficult to apply to the surface with a gloved hand. Upon completion of the operation, a noticeable film of DMMP was evident on the surface; however, no trace of powder was evident. The panel was subsequently evaluated for residual DMMP. The decontamination efficacy achieved by the IMT was determined to be 92.7±1.2%. The DMMP conversion was about 43.3±5.1%.

Despite the decontamination operation performed with a fume hood, no loose media was observed to blow around within the fume hood during the operation. This represents a significant advantage over decontamination operations performed using known loose media, as inhalation and contact hazards are avoided.

### Example 3

This example describes, according to an embodiment disclosed herein, decontamination of a surface via treatment with a textile comprising immobilized zirconium oxyhydroxide in the form of a dual-sided mitt. A 10.7 square foot aluminum surface was contaminated with 10 g of CW agent simulant DMMP. The DMMP was applied as small droplets evenly across the surface. A dual-sided decontamination mitt 7.5″ wide and 11″ in length was prepared. The mitt was comprised of textile comprising 0.18 g per square inch (g/in²) immobilized zirconium oxyhydroxide on both external sides and laminated with a polyethylene film liner. The mitt consisted of a fold-over front edge and was laminated along the side edges. The mitt was contacted with the panel surface. Upon completion of the decontamination operation, no film of DMMP was evident on the surface. The panel was subsequently evaluated for residual DMMP. The decontamination efficacy achieved by the IMT was determined to be 99.8±0.3%. The mitt was evaluated for reactivity. The DMMP conversion was about 42.4±5.0%.

A 10.7 square foot aluminum surface was contaminated with 15 g of CW agent simulant DMMP. The DMMP was applied as small droplets evenly across the surface. A dual-sided decontamination mitt 7.5″ wide and 11″ in length was prepared. The mitt was comprised of textile comprising 0.18 g per square inch (g/in²) immobilized zirconium oxyhydroxide on both external sides and laminated with a polyethylene film liner. The mitt consisted of a fold-over front edge and was laminated along the side edges. The mitt was contacted with the panel surface. Upon completion of the operation, no DMMP film was evident on the panel surface. The panel was subsequently evaluated for residual DMMP. The decontamination efficacy achieved by the IMT was determined to be 99.9%. The mitt was evaluated for reactivity. The DMMP conversion was about 28.7%.

A 10.7 square foot aluminum surface was contaminated with 3 g of CW agent simulant DMMP. The DMMP was applied as small droplets evenly across the surface. A dual-sided decontamination mitt 7.5″ wide and 11″ in length was prepared. The mitt was comprised of textile comprising 0.18 g per square inch (g/in²) immobilized zirconium oxyhydroxide on both external sides and laminated with a polyethylene film inner liner. The mitt consisted of a fold-over front edge and was joined, here laminated along the side edges. The mitt was contacted with the panel surface. Upon completion of the operation, no DMMP film was evident on the panel surface. The panel was subsequently evaluated for residual DMMP. The decontamination efficacy achieved by the IMT was determined to be 99.97%. The mitt was evaluated for reactivity. The DMMP conversion was about 78.1%.

A 10.7 square foot aluminum surface was contaminated with 10 g of CW agent simulant CEPS. The CEPS was applied as small droplets evenly across the surface. A dual-sided decontamination mitt 7.5″ wide and 11″ in length was prepared. The mitt was comprised of textile comprising 0.18 g per square inch (g/in²) immobilized zirconium oxyhydroxide on both external sides and laminated with a polyethylene film inner liner. The mitt consisted of a fold-over front edge and was laminated along the side edges. The mitt was contacted with the panel surface. Upon completion of the operation, no film of CEPS was evident on the panel surface. The panel was subsequently evaluated for residual CEPS. The decontamination efficacy achieved by the IMT was determined to be 99.9±0.0%. The mitt was evaluated for reactivity. The CEPS conversion was about 38.2±2.9%.

A 10.7 square foot aluminum surface was contaminated with 10 g of salt water plus 10 g of CW agent simulant DMMP. Both salt water and DMMP were applied as small droplets evenly across the surface. A dual-sided decontamination mitt 7.5″ wide and 11″ in length was prepared. The mitt was comprised of textile comprising 0.18 g per square inch (g/in²) immobilized zirconium oxyhydroxide on both external sides and laminated with a polyethylene film inner liner. The mitt consisted of a fold-over front edge and was laminated along the side edges. The mitt was contacted with the panel surface. Upon completion of the operation, no DMMP film was evident on the panel surface. The panel was subsequently evaluated for residual DMMP. The decontamination efficacy achieved by the IMT was determined to be 98.7±0.9%. The mitt was evaluated for reactivity. The DMMP conversion was about 45.6±4.7%.

Despite the decontamination operation performed with a fume hood, no loose media was observed to blow around within the fume hood during the operation. This represents a significant advantage over decontamination operations performed using known loose media, as inhalation and contact hazards are avoided.

A decontamination mitt according to one embodiment disclosed herein was applied to the loaded cartridge associated with a rifle. Following application, no difficulty was encountered in removing the cartridge from the rifle, illustrating the advantages associated with the use of a decontamination mitt disclosed herein.

A decontamination mitt according to one embodiment disclosed herein was applied to the keyboard of a laptop computer. Following application, no issues were encountered in operating the laptop keyboard, illustrating the advantages associated with the use of a decontamination mitt disclosed herein.

### Example 4

This example describes decontamination of a computer screen using a zirconium oxyhydroxide immobilized textile in the form of a mitt. A computer screen with an area approximately 0.7 ft² was contaminated with 0.7 g of CW agent simulant DMMP. A dual-sided decontamination mitt 7.5″ wide and 11″ in length was prepared. The mitt was comprised of textile loaded comprising 0.18 g per square inch (g/in²) immobilized zirconium oxyhydroxide on the external sides and laminated with a polyethylene film liner. The mitt consisted of a fold-over front edge and was joined, here laminated along the side edges. The mitt was contacted with the panel surface. Upon completion of the operation, no DMMP film was evident on the panel surface. The computer screen was subsequently evaluated for residual DMMP. The decontamination efficacy achieved by the decontamination mitt exceeded about 99.9%.

Despite the decontamination operation performed with a fume hood, no loose media was observed to blow around within the fume hood during the operation. This represents a significant advantage over decontamination operations performed using known loose media, as inhalation and contact hazards are avoided.

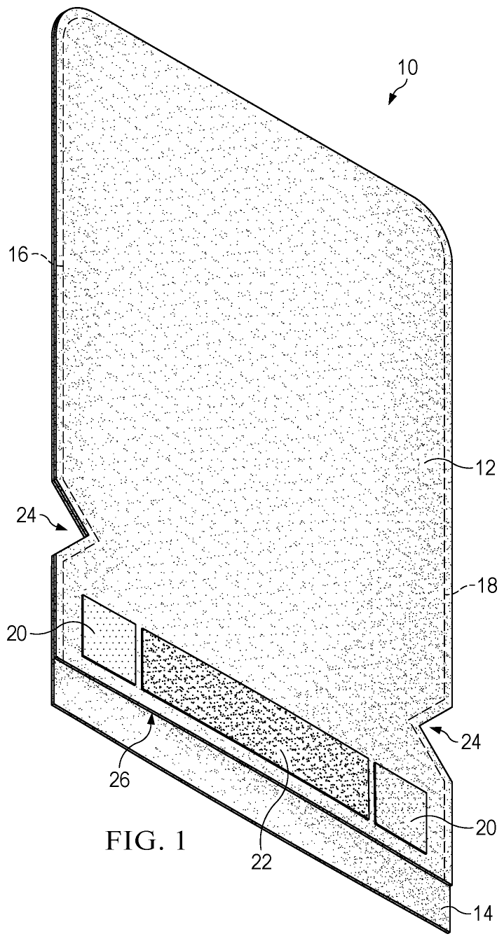

FIG. 1 shows a front perspective view of a mitt, wherein the mitt is in a ready-to-be-worn configuration. The mitt 10 comprises a front panel 12 and a back panel 14, joined at the left and right sides by left seam 16 and right seam 18, respectively. A notch 24 is provided in the right side of the mitt 10, and another notch 24 is provided in the left side. An opening 26 is defined by the front and back panels 14, 16, wherein a user may insert her hand into the opening 26. Two hook pads 20 and a loop pad 22 are fixed to the front panel 12, and are positioned to allow the mitt to be closed around the user's wrist, such as for example via Velcro® hook and loop pads.

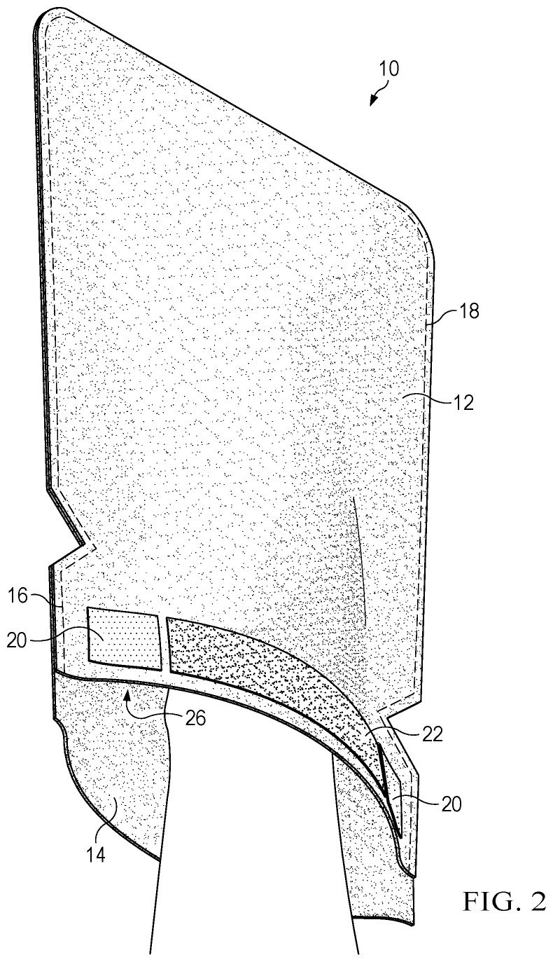

FIG. 2 shows a front perspective view of the mitt shown in FIG. 1, wherein the mitt is in a hand receiving configuration. The front panel 12 and back panel 14 may be pulled apart at the opening 26 to an extent sufficient to allow the user to insert her hand.

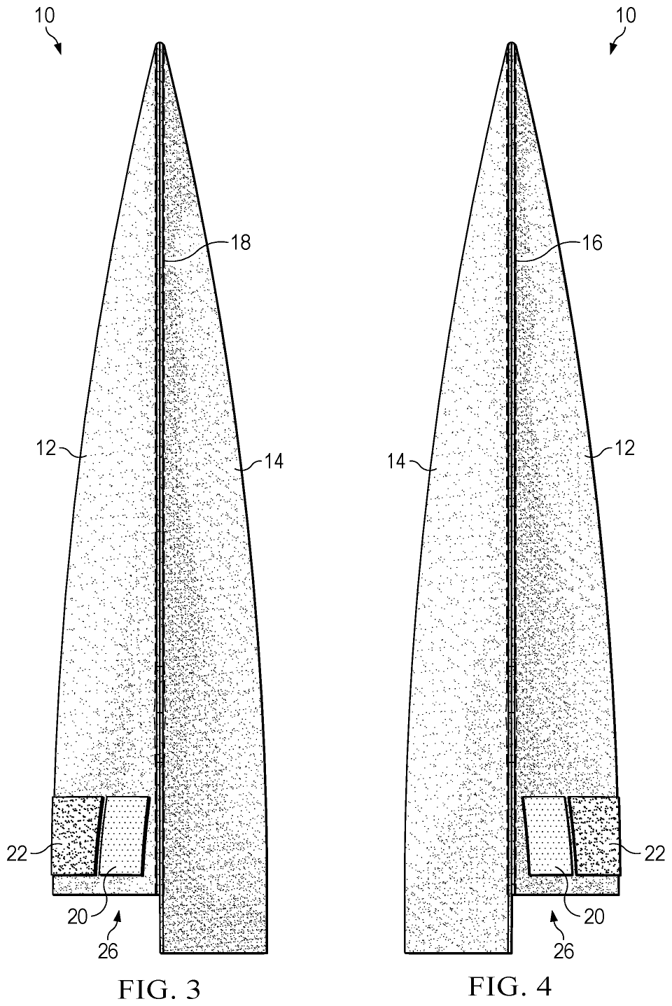

FIGS. 3 and 4 show right-side and left-side views, respectively, of the mitt 10 in the hand receiving configuration as shown in FIG. 2. The back panel 14 may be longer at the opening 26 than the front panel 12. This difference in the sizes of the panels may allow a user to more easily grab and pull open the sides of the opening 26.

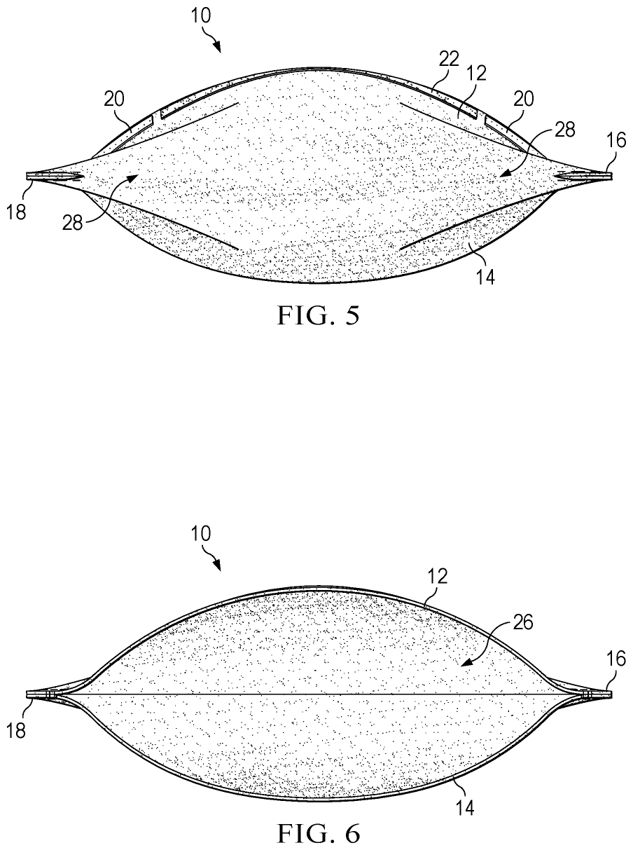

FIG. 5 shows a top view of the mitt in the hand receiving configuration as shown in FIGS. 2-4. The front panel 12 and the back panel 14 may be joined at the top of the mitt 10 without a discontinuity. In particular, the two panels may be formed from the same piece of material, by folding over a single piece of material on itself so there is a fold 28 at the top, and the sides may be sewn together by seams 16, 18.

FIG. 6 shows a bottom view of the mitt in the hand receiving configuration as shown in FIGS. 2-5. The front panel 12 and back panel 14 may be pulled apart at the opening 26 to an extent sufficient to allow the user to insert her hand.

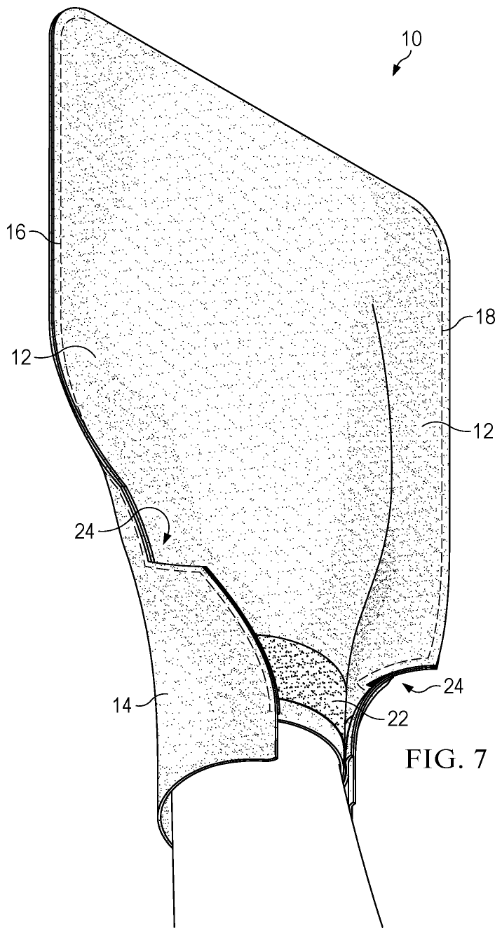

FIG. 7 shows a front perspective view of the mitt shown in FIGS. 1-6, wherein the mitt is in a worn configuration. A user's hand is shown inserted into the opening 26 (see FIG. 2) and the mitt 10 is closed around the user's wrist. At the user's wrist, the two sides of the mitt 10 are pulled around the user's wrist until the hook pads 20 (see FIG. 2) contact and engage the loop pad 22. The notches 24 in the sides of the mitt 10 allow the wrist portions of the mitt 10 to more easily wrap around the user's writs while the hand portions of the mitt 10 are allowed to remain substantially flat.

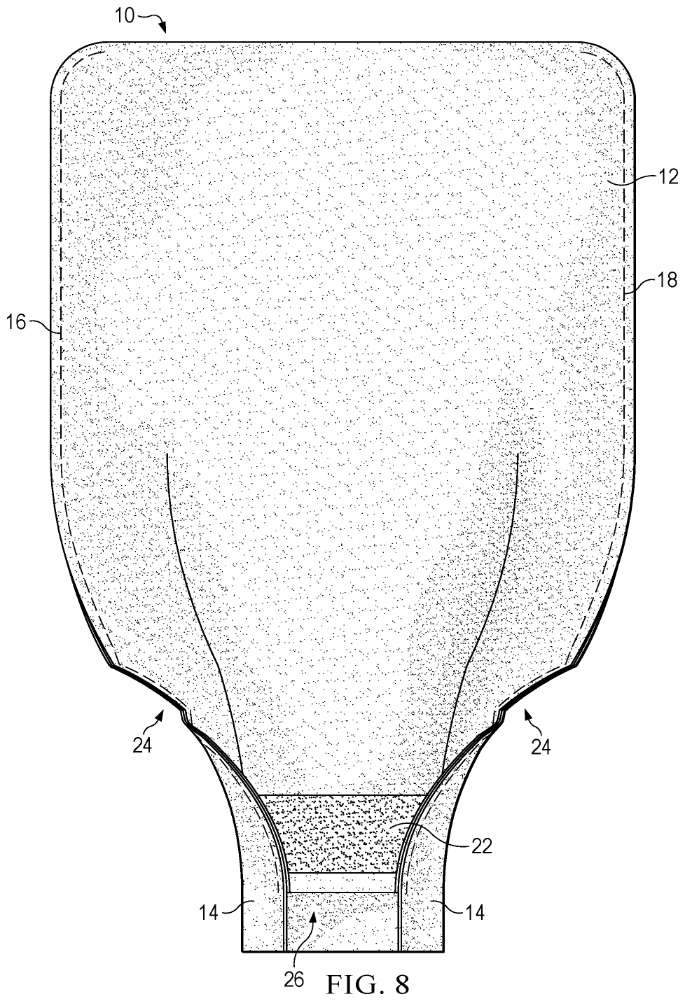

FIG. 8 shows a front elevation of the mitt in the worn configuration as shown in FIG. 7.

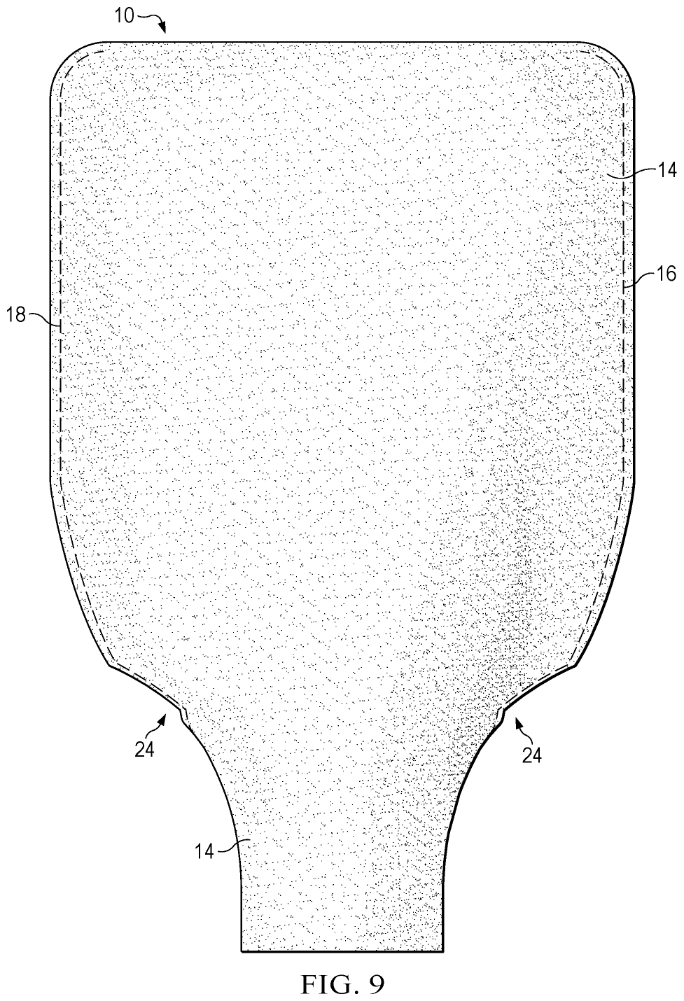

FIG. 9 a rear elevation of the mitt in the worn configuration as shown in FIGS. 7-8.

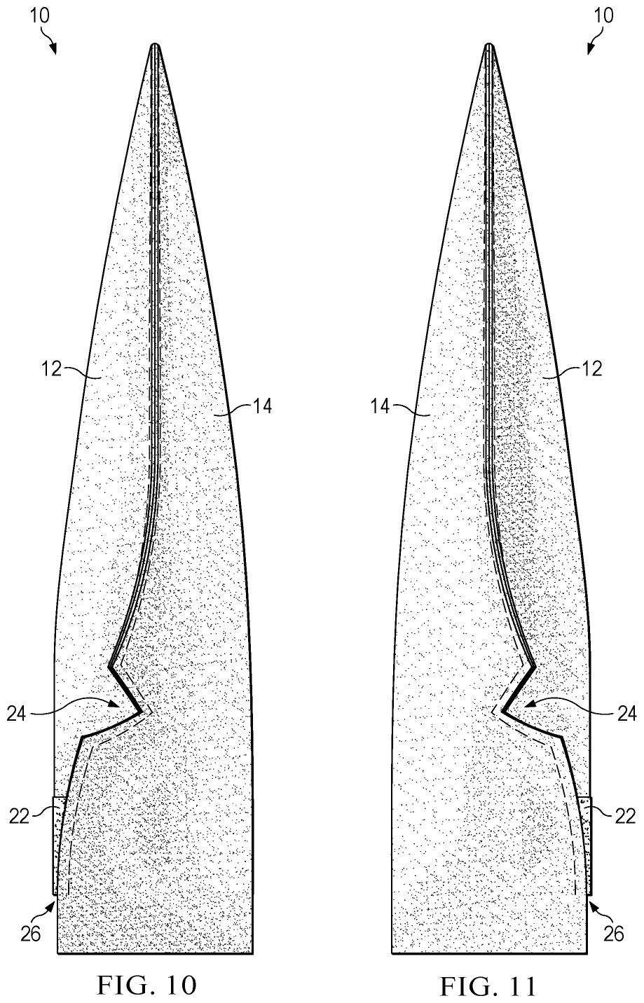

FIGS. 10 and 11 show right-side and left-side views, respectively, of the mitt 10 in the worn configuration as shown in FIGS. 7-9.

FIG. 11 shows a left side view of the mitt in the worn configuration as shown in FIGS. 7-10.

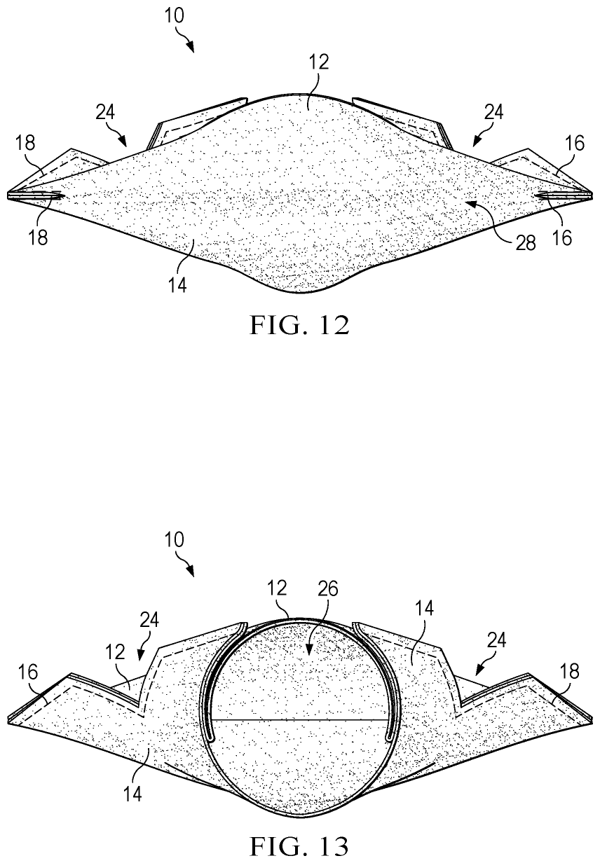

FIG. 12 shows a top view of the mitt in the worn configuration as shown in FIGS. 7-11. A fold 28 at the top of the mitt 10 joins the front panel 12 to the back panel 14. A left seam 16 and a right seam 18 join the sides of the panels.

FIG. 13 shows a bottom view of the mitt in the worn configuration as shown in FIGS. 7-12. An opening 26 may be sized to fit around a user's wrist (not shown).

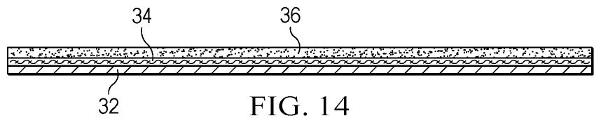

FIG. 14 shows a cross-sectional side view of a panel of a mitt. The panel may have a liner layer 32, a textile layer 34, and a powdered media layer 36.

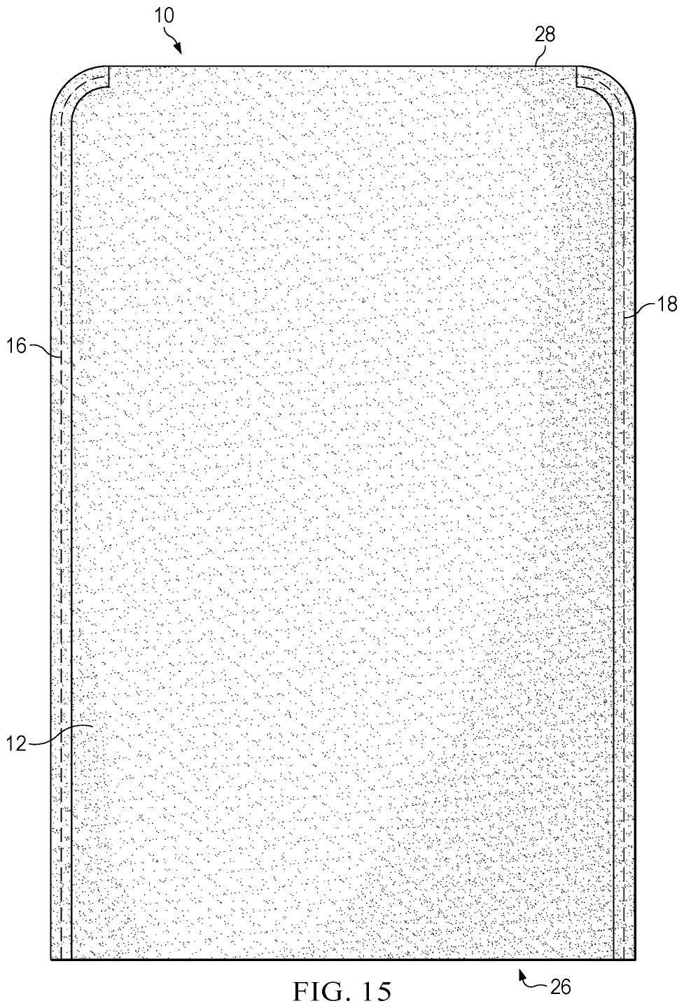

FIG. 15 shows a front view of a mitt. The mitt 10 may have a hand insert area comprising an opening 26 defined by a front panel 12 and a back panel (not shown). The panels may comprise a single piece of material bent over itself at a fold 28 at the top, and the sides may be joined by a left seam 16 and a right seam 18.

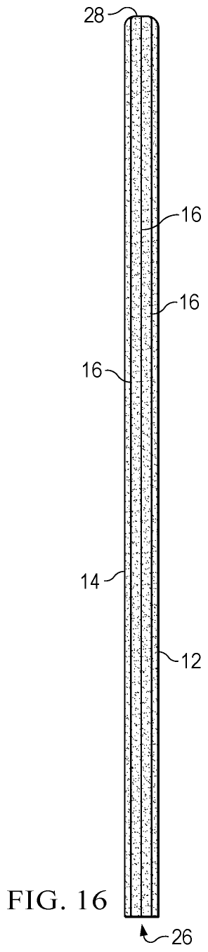

FIG. 16 shows a left-side view of the mitt shown in FIG. 15. The mitt may have a fold 28 at the top, and the front panel 12 may be joined to the back panel 14 by a left seam 16 and a right seam (not shown) so that the panels define an opening 26 at the bottom of the mitt 10.

What is claimed is:

1. A process for removing CW agents, toxic industrial chemicals or other hazardous materials from a surface, the process comprising
contacting the surface with an immobilized media textile (“IMT”) to remove CW agents, toxic industrial chemicals, or hazardous materials and
disposing of the IMT with the removed CW agents, toxic industrial chemicals, or hazardous materials thereon.

2. A process according to claim 1, wherein the IMT is configured in the form of a mitt having first and second sides.

3. A process according to claim 2, wherein the mitt comprises immobilized media on at least one of the first and second sides.

4. A process according to claim 2, wherein the mitt comprises immobilized media on the first and second sides.

5. A process according to claim 4, wherein the first and second sides comprise different immobilized media.

6. A process according to claim 2, wherein the disposing step further comprises turning the mitt inside-out following completion of the process.

7. A process according to claim 4, wherein the disposing step further comprises turning the mitt inside-out following completion of the process.

8. A process according to claim 1, wherein the contacting the surface step comprises rubbing the IMT on the surface.

9. A process according to claim 1, wherein the IMT comprises a media selected from the group consisting of (a) absorptive media and (b) absorptive and reactive media.

10. A process according to claim 1, wherein the media of the IMT comprises zeolites.

11. A process according to claim 1, wherein the media of the IMT comprises activated carbon.

12. A process according to claim 1, wherein the media of the IMT is selected from the group consisting of metal oxides, metal oxyhydroxides, mixed-metal oxyhydroxides, zirconium oxyhydroxide and mixtures thereof.

13. A process according to claim 1, wherein the media of the IMT comprises pseudo-boehmite.

14. A textile hand mitt for the efficient removal of contaminants from a surface in the field, said hand mitt comprising
first and second outward facing textile sides, each side for contacting the surface,
the first and second textile sides having edges and being joined together along the edges to form a hand mitt,
each of the first and second textile sides of the mitt comprising at least one immobilized contaminant surface removal media, and
an internal liner layer on the backside of the first and second outward facing textile sides of the mitt.

15. A mitt according to claim 14, wherein the immobilized contaminant removal media comprises (a) absorptive media or (b) absorptive and reactive media.

16. A mitt according to claim 14, wherein the mitt has at least about a 98% CW agent simulant surface removal efficiency for contaminant simulants DMMP and CEPS per 10.7 square/feet of aluminum surface.

17. A mitt according to claim 14, wherein the contaminant surface removal media comprises zeolites.

18. A mitt according to claim 14, wherein the contaminant surface removal media comprises activated carbon.

19. A mitt according to claim 14, wherein the contaminant surface removal media is selected from the group consisting of metal oxides, metal oxyhydroxides, mixed-metal oxyhydroxides, zirconium oxyhydroxide and mixtures thereof.

20. A mitt according to claim 14, wherein the contaminant surface removal media comprises pseudo-boehmite.

21. A mitt according to claim 14, wherein each of the first and second textile sides of the hand mitt are comprised of different immobilized contaminant surface removal media.

22. A dual-sided mitt for removal of CW agent contaminants from a surface in the field, the mitt comprising:
first and second outward facing textile sides, each side for contacting the surface,
the first and second textile sides each having edges and being joined together along the edges except one to form a mitt, wherein the edges not joined allow for the insertion of a hand and at least a partial forearm into the mitt,
each of the first and second textile sides of the mitt comprising at least one metal oxyhydroxide contaminant surface removal media immobilized on the outward facing textile sides for removal of CW agent contaminants from the surface upon contact of each textile side with the surface, and
an internal liner barrier layer on the backside of the first and second outward facing joined textile sides of the mitt for protecting an inserted hand and a partial forearm from CW agent contaminants.

23. A mitt according to claim 22, wherein the contaminant surface removal media immobilized on the textile sides is selected from the group of metal oxyhydroxides consisting of zirconium oxyhydroxide, aluminum oxyhydroxide, pseudo-boehmite and mixed-metal oxyhydroxides.

24. A mitt according to claim 22, wherein the mitt has at least about a 98% CW agent simulant surface removal efficiency for CW contaminant simulants DMMP and CEPS per 10.7 square feet of aluminum surface.

25. A mitt according to claim 22, wherein the joined together textile edges include at least one fold-over edge.

26. A mitt according to claim 22, wherein the mitt is thumbless.
